(19) United States
(12) Patent Application Publication
(10) Pub. No.: US 2017/0306663 A1
(43) Pub. Date: Oct. 26, 2017

(54) RADIAL END DOOR LOCKING ROD, CAM AND KEEPER

(71) Applicant: Trinity Parts & Components, LLC, Dallas, TX (US)

(72) Inventor: Robert J. Cencer, Tipton, MI (US)

(21) Appl. No.: 15/492,217

(22) Filed: Apr. 20, 2017

Related U.S. Application Data
(60) Provisional application No. 62/325,756, filed on Apr. 21, 2016.

(51) Int. Cl. E05B 83/10; E05B 83/14; E05B 77/44; E05B 85/04; B61D 19/00

(52) U.S. Cl. CPC E05B 83/10; E05B 85/04; B61D 19/001; E05B 77/44; E05B 83/14

(57) ABSTRACT

A railcar locking system that includes a railcar with a first radial door and second radial door. The first radial door includes a first keeper on the first radial door and a second keeper disposed above the first keeper on the first radial door. The second radial door includes a first hinge on the second radial door and a second hinge disposed above the first hinge on the second radial door. The second radial door further includes a locking rod that includes a first cam disposed at a first end of the locking rod and a second cam disposed at a second end of the locking rod. The first cam is configured to engage with a first lobe of the first keeper and the second cam is configured to engage with a second lobe of the second keeper when the locking rod is in the locked position.

### CROSS-REFERENCE TO RELATED APPLICATIONS

The present application claims benefit of U.S. Provisional Patent Application No. 62/325,756 filed Apr. 21, 2016 by Robert J. Cencer, and entitled “RADIAL END DOOR LOCKING ROD, CAM AND KEEPER,” which is incorporated herein by reference as if reproduced in their entirety.

### TECHNICAL FIELD

The present disclosure relates generally to providing a locking assembly for a railcar.

### BACKGROUND

Existing railcars may only provide a seal point at the lower end of the railcar end doors. The seal point can be secured to keep the lower ends of the end doors from operating. Upper portions of the end doors may be pried open after pulling the upper interior door locking pin, which allows access into and out of the railcar for theft and illegal ridership without removing the seal at the bottom of the end door.

Some existing railcars use top door guides to tie the top of the end doors to the roof of the railcar. However, top door guides decrease the usable vertical clearance of the upper deck on railcar and may add to complexity, cost, and/or maintenance of the railcar. In some instances, international railroads may apply a removable locking device or cable seals to the upper grab handles on the end doors to prevent them from being pried open without the removal of the seal at the lower end of the doors. The locking devices and cable seals must be removed at the border which requires using ladders, keys, and other tools. Locking devices have to be returned to the origin to be reapplied. Sometimes the locking devices are missed at the border which may create problems when a railcar car reaches its destination. Thus, it is desirable to provide a solution for securing railcar end doors to protect a railcar from theft and other malicious activities.

### SUMMARY

In one embodiment, the disclosure includes a railcar locking system that includes a railcar with a first radial door and second radial door. The first radial door has a first keeper disposed on a lower portion of the first radial door and a second keeper disposed above the first keeper on the first radial door. The first keeper has a first lobe and the second keeper has a second lobe. The second radial door has a first hinge disposed on a lower portion of the second radial door and a second hinge disposed above the first hinge on the second radial door. The first hinge has a first mounting bracket and the second hinge has a second mounting bracket. The second radial door further includes a locking rod with a first cam disposed at a first end of the locking rod and a second cam disposed at a second end of the locking rod. The first cam is configured to engage with the first lobe of the first keeper and the second cam is configured to engage with the second lobe of the second keeper when the locking rod is in the locked position. The locking rod is configured to rotate within the first mounting bracket and the second mounting bracket. The second radial door further includes a locking rod handle coupled to the locking rod. The locking rod handle is configured such that rotating the locking rod handle about the locking rod rotates the first cam and the second cam about the locking rod. The locking rod is configured to at least partially align the first radial door and the second radial door when the locking rod is in the locked position. The first radial door is secured to the second radial door when the locking rod is in the locked position.

In another embodiment, the disclosure includes a railcar locking method that includes positioning a first edge of a first radial door on a railcar adjacent to a second edge of a second radial door on the railcar. The first radial door has a first keeper has a first lobe and a second keeper has a second lobe. The second radial door has one or more hinges, a locking rod coupled to the one or more hinges, a first cam disposed at a first end of the locking rod, and a second cam disposed at a second end of the locking rod. The method further includes rotating the locking rod about the one or more hinges to position the locking rod adjacent to the first keeper and the second keeper. The first cam is adjacent to the first keeper and the second cam is adjacent to the second keeper when the locking rod is positioned adjacent to the first keeper and the second keeper. The method further includes rotating the locking rod to engage the locking rod with the first keeper and the second keeper. The first cam is engaged with the first lobe and the second cam is engaged with the second lobe when the locking rod is engaged with the first keeper and the second keeper. When the locking rod is engaged with the first keeper and the second keeper, the first radial door and the second radial door are at least partially aligned. The first radial door is secured to the second radial door when the locking rod is engaged with the first keeper and the second keeper.

In yet another embodiment, the disclosure includes an apparatus that includes a first keeper configured to be disposed on a first door and a second keeper configured to be disposed above the first keeper on the first door. The first keeper has a first lobe and the second keeper has a second lobe. The apparatus further includes a first hinge configured to be disposed on a second door and a second hinge configured to be disposed above the first hinge on the second door. The first hinge has a first mounting bracket and the second hinge has a second mounting bracket. The apparatus further includes a locking rod with a first cam disposed at a first end of the locking rod and a second cam disposed at a second end of the locking rod. The first cam is configured to engage with the first lobe of the first keeper and the second cam is configured to engage with the second lobe of the second keeper when the locking rod is in the locked position. The locking rod is configured to rotate within the first mounting bracket and the second mounting bracket. The apparatus further includes a locking rod handle coupled to the locking rod. The locking rod handle is configured such that rotating the locking rod handle about the locking rod rotates the first cam and the second cam about the locking rod. The locking rod is configured to at least partially align the first door and the second door when the locking rod is in the locked position. The first door is secured to the second door when the locking rod is in the locked position.

Various embodiments present several technical advantages, such as providing a railcar locking system that provides enhanced security features for protecting a railcar and its contents. The locking system allows radial doors to be secured both to each other as well as to the roof and/or the deck of a railcar. In addition, the locking system allows the radial doors to be coupled to each other at multiple locations along the length of the radial doors which provides a more secure connection between the radial doors. Unlike conventional systems, the locking system allows radial doors to be properly aligned while securing the doors to each other, which also provides a more secure connection between the radial doors.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an end view of an embodiment of a railcar with a locking system;

FIG. 2 is a front view of an embodiment of a locking rod portion of the locking system;

FIG. 3 is a front view of an embodiment of a keeper portion of the locking system;

FIG. 4 is a top view of an embodiment of the locking system in an unlocked position;

FIG. 5 is a top view of an embodiment of the locking system in a locked position; and

FIG. 6 is a flowchart of an embodiment of a railcar locking method using the locking system.

### DETAILED DESCRIPTION

Existing railcars may only provide a seal point at the lower end of the end doors. The seal point can be secured to keep the lower ends of the doors from operating. Upper portions of the end doors may be pried open after pulling the upper interior door locking pin, which allow access into and out of the railcar for theft and illegal ridership without removing the seal at the bottom of the end door.

Disclosed herein are various embodiments of a railcar locking system for a railcar such as a box car or an autorack car. The locking system is configured to allow an operator to operate the locking system while standing on the ground. The locking system allows an operator to couple a pair of radial doors together which secures the radial doors and prevents them from operating and being pried open. The locking system uses multiple cams and keepers that engage with each other to both align and secure the radial doors. To lock the radial doors to each other, the operator positions a locking rod with cams adjacent to corresponding keepers and rotates the locking rod to transition the locking system 102 to a locked position. To unlock the locking system 102, the operator rotates the locking rod in the opposite direction to disengage the locking rod cams from the keepers.

The locking system provides several technical advantages over existing systems. For example, conventional radial doors do not have the ability to self align with each other. In contrast, as the locking system transitions to the locked position, the cams and keeper engage with each other to pull the radial doors together and to align the radial doors with each other. As another example, conventional radial doors are typically secured to either the roof or deck of a railcar and do not have the ability to be secured with each other. The locking system allows radial doors to be secured both with each other as well as to the roof and/or the deck of the railcar. In addition, the locking system allows the radial doors to be coupled to each other at multiple locations along the length of the radial doors which provides a more secure connection between the radial doors.

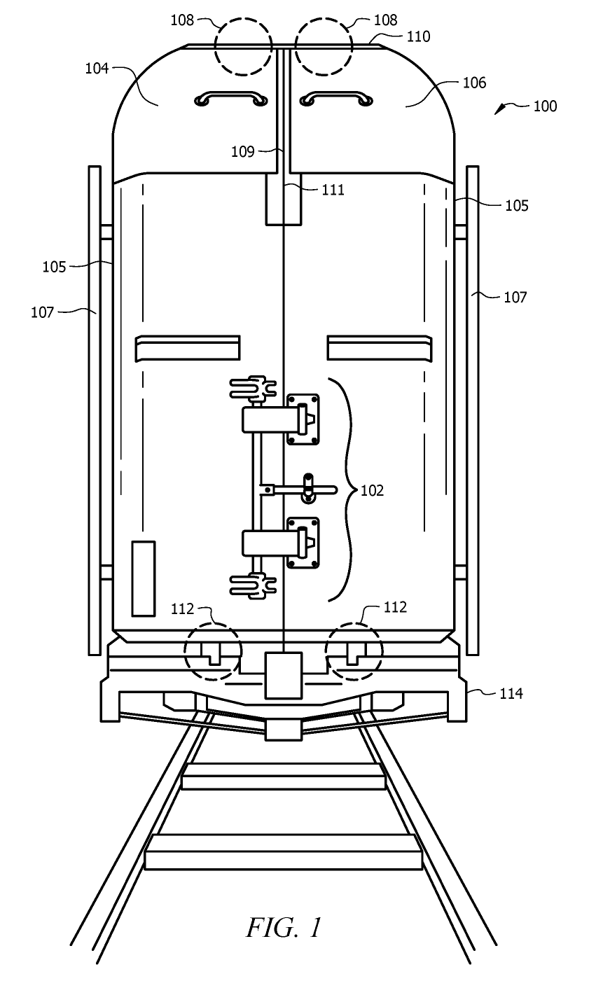

FIG. 1 is an end view of an embodiment of a railcar 100 with a locking system 102. Examples of a railcar 100 include, but are not limited to, a box car and an autorack car. The railcar 100 comprises a first radial door 104 and a second radial door 106, which are the end doors of the railcar 100. The first radial door 104 and the second radial door 106 are each configured to have at least a slight bend or curvature, which together forms an arm when The first radial door 104 and the second radial door 106 are in a closed configuration. In the open configuration, the first radial door 104 and the second radial door 106 are configured to slide to a stored position that permits loading and unloading of the railcar 100. For example, the first radial door 104 and the second radial door 106 may each slide into a space between a side wall 105 of the railcar 100 and a ladder panel 107 of the railcar 100 when they are in their stored position.

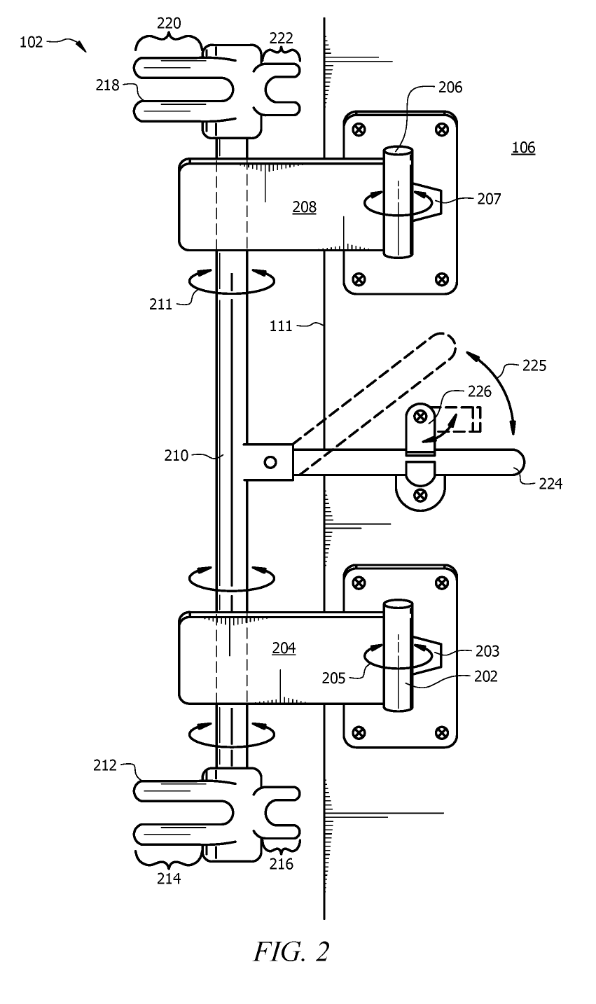

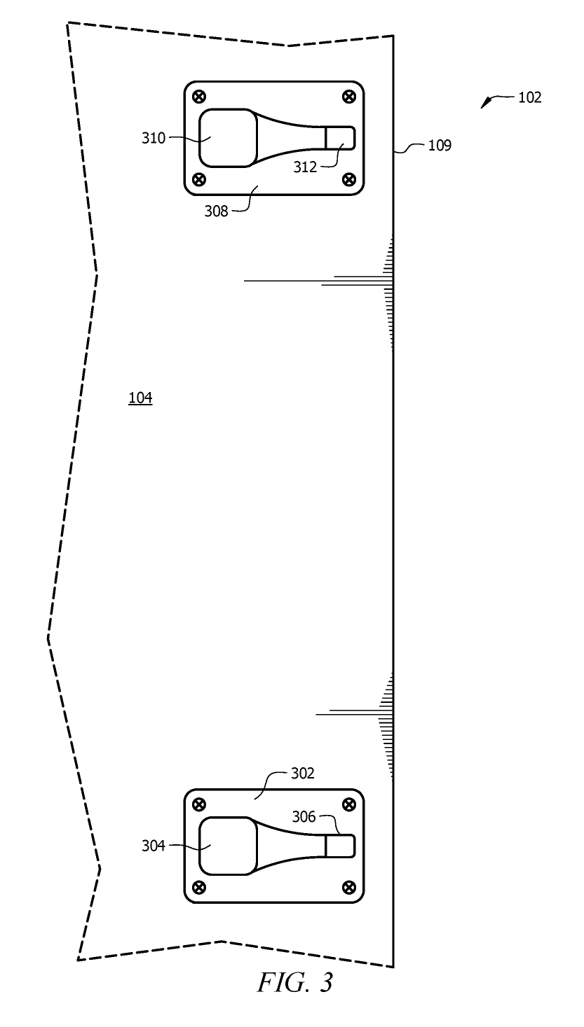

The locking system 102 may be installed on either or both ends of the railcar 100. For example, the locking system 102 may be installed on the B-end of the railcar 100. The locking system 102 is generally configured to at least partially align the first radial door 104 and the second radial door 106 when the locking system 102 is in a locked position. Conventional radial doors move independently and do not have the ability to self align with each other. As the locking system 102 transitions to the locked position, the locking system 102 couples first radial door 104 to the second radial door 106, which allows the first radial door 104 and the second radial door 106 to align with each other. The locking system 102 is configured to secure the first radial door 104 and the second radial door 106 to each other when the locking system 102 is in the locked position. Conventional radial doors do not have the ability to connect to each other. Typically, conventional radial door are only secured to either the roof 110 or the deck 114 of the railcar 100. The locking system 102 allows the first radial door 104 and the second radial door 106 to be both coupled to each other as well as to the roof 110 and/or the deck 114 of the railcar 100. Additional details about the locking system are described in FIGS. 2-3.

In one embodiment, the railcar 100 comprises one or more other door locking or latching mechanisms. Examples of locking or latching mechanisms include, but are not limited to, locking pins, slide bolts, shutter latches, bar latches, and hook latches. The one or more locking mechanisms may be mounted to the interior and/or the exterior of the railcar 100. In one example, the railcar 100 comprises a locking mechanism 108 configured to secure the first radial door 104 and/or the second radial door 106 to the roof 110 of the railcar 100. As another example, the railcar 100 comprises a locking mechanism 112 configured to secure the first radial door 104 and/or the second radial door 106 to a deck 114 of the railcar 100. In other examples, the railcar 100 may comprise the first locking mechanism 108 and the second locking mechanism 112 to secure each of the doors to both the roof 110 and the deck 114 of the railcar 100. Using additional door locking mechanisms in conjunction with the locking system 102, allows the first radial door 104 and the second radial door 106 to be both coupled to each other as well as the roof 110 and/or the deck 114 of the railcar 100. In this configuration, the first radial door 104 and the second radial door 106 have multiple points of contacts for securing the doors, which makes them harder to pry open.

FIGS. 2 and 3 show different portions of the locking system 102 that are installed in opposing radial doors of the railcar 100. FIG. 2 shows a locking rod portion of the locking system 102 that is installed on the second radial door 106. FIG. 3 shows a keeper portion of the locking system 102 that is installed on the first radial door 104. In another embodiment, the locking rod portion may be installed on the first radial door 104 and the keeper portion may be installed on the second radial door 106.

FIG. 2 is a front view of an embodiment of a locking rod portion of the locking system 102. The locking rod portion comprises a first hinge 202 and a second hinge 206 operably coupled to a locking rod 210. The first hinge 202, the second hinge 206, and the locking rod 210 are disposed proximate to an edge 111 of the second radial door 106.

The first hinge 202 and the second hinge 206 may be mounted to the second radial door 106 using any suitable technique as would be appreciated by one of ordinary skill in the art. For example, the first hinge 202 and the second hinge 206 may each comprise a backing plate that allows the first hinge 202 and the second hinge 206 to be bolted to the second radial door 106.

In one embodiment, the first hinge 202 is disposed on a lower portion of the second radial door 106. For example, the first hinge 202 may be positioned near the deck 114 of the railcar 100. The second hinge 206 is disposed above the first hinge 202 on the second radial door 106. The locking system 102 may be configured with any suitable spacing between the first hinge 202 and the second hinge 206 in a vertical direction along the second radial door 106. For example, the first hinge 202 and the second hinge 206 may be one foot apart, two feet apart, three feet apart, etc. In one embodiment, the second hinge 206 is proximate to a center portion of the second radial door 106. For example, the second hinge 206 may be positioned near the middle of the second radial door 106. In another embodiment, the second hinge 206 is proximate to the roof 110 of the railcar 100. In other embodiments, the second hinge 206 may be positioned in any other suitable position on the second radial door 106. In general, the first hinge 202 and the second hinge 206 are positioned to be substantially aligned with corresponding keepers on the first radial door 104. Additional details about the keepers on the first radial door 104 are described in FIG. 3.

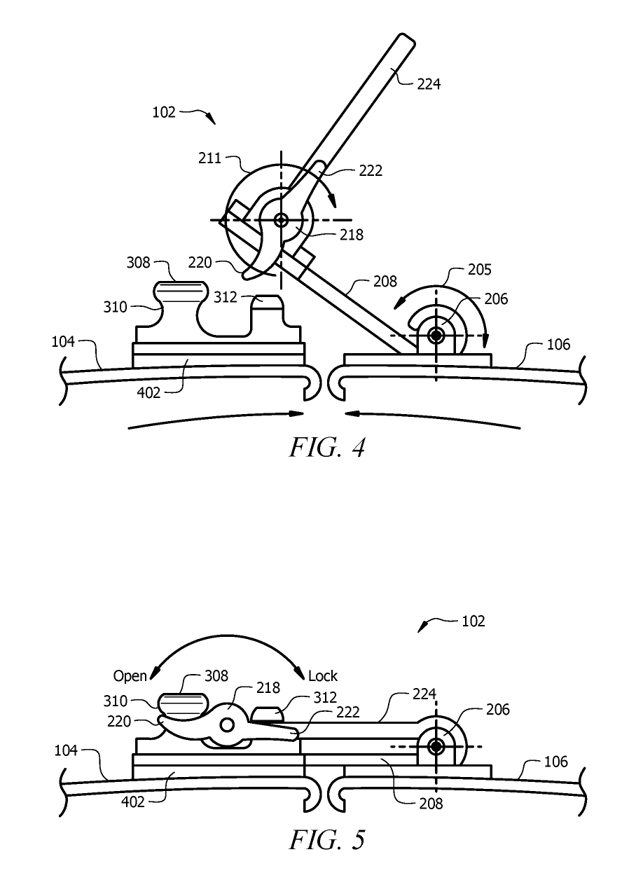

In one embodiment, the first hinge 202 is a clevis and hinge pin with a mounting plate. In other embodiments, the first hinge 202 may be any other suitable type of hinge as would be appreciated by one of ordinary skill in the art. The first hinge 202 is configured to allow the locking rod 210 to pivot about the first hinge 202 (shown as rotation 205) to position the locking rod 210. For example, the locking rod 210 may pivot about the first hinge 202 in order to position the locking rod 210 adjacent to keepers prior to engaging the locking rod 210 with the keepers. Additional information about positioning the locking rod 210 is described in FIG. 4.

In one embodiment, the first hinge 202 comprises a first mounting bracket 204 and a first hinge gag 203. The first mounting bracket 204 is configured to couple the locking rod 210 to the first hinge 202. In one embodiment, the first mounting bracket 204 comprises an internal bearing. The internal bearing is configured to allow the locking rod 210 to pass through the internal bearing and to allow the locking rod 210 to rotate within the internal bearing (shown as rotation 211). In other embodiments, the first mounting bracket 204 may comprise any other suitable type of mechanism for coupling the locking rod 210 to the first hinge 202 and/or for allowing the locking rod 210 to rotate. The first hinge gag 203 is configured to restrict the motion (i.e. rotation 205) of the first hinge 202. For example, the first hinge gag 203 may be metal tab that prevents excessive rotation of the first hinge 202. In one embodiment, the first hinge 202 further comprises a torsional spring (not shown) that is configured to keep the first hinge 202 in a closed position to assist with locking the locking system 102.

The second hinge 206 is configured similar to the first hinge 202 and comprises a second mounting bracket 208 and a second hinge gag 207 configured similar to the first mounting bracket 204 and the first hinge gag 203, respectively.

The locking rod 210 comprises a first cam 212 and a second cam 218. The first cam 212 is disposed at a first end of the locking rod 210 and the second cam 218 is disposed at a second end of the locking rod 210. The first cam 212 is configured to engage with a first keeper (e.g. keeper 302) on the first radial door 104 and the second cam 218 is configured to engage with a second keeper (e.g. keeper 308) on the first radial door 104.

The first cam 212 comprises a first hook portion 214 and a second hook portion 216. In one embodiment, the first hook portion 214 comprises a pair of hooks configured to engage with a first lobe (e.g. lobe 304) of a keeper. The hooks are configured to hook underneath the first lobe and apply a force (e.g. a pulling force) on the first lobe to couple the locking rod 210 with the first keeper. For example, the pair of hooks may be spaced to allow the first hook portion 214 to fit around a narrow portion of the first lobe. The spacing is narrower than the diameter of the first lobe, which prevents the first hook portion 214 from sliding past the first lobe.

In one embodiment, the second hook portion 216 comprises a second pair of hooks configured to engage with a second lobe (e.g. lobe 306) of a keeper. The second pair of hooks are configured to engage the second lobe by hooking over and/or around the second lobe. The second hook portion 216 restricts the rotation of the locking rod 210 when the second pair of hooks are engaged with the second lobe.

The second cam 218 is configured similar to the first cam 212 and comprises a first hook portion 220 and a second hook portion 222 configured similar to the first hook portion 214 and the second hook portion 216 of the first cam 218.

In other embodiments, the locking rod 210 may comprise any other suitable number of cams. For example, the locking rod 210 may comprise one cam, two cams, three cams, and so on.

The locking rod 210 further comprises a locking rod handle 224 coupled to the locking rod 210. The locking rod handle 224 is generally configured to allow an operator to rotate the locking rod 210 by pivoting the locking rod handle 224 about the locking rod 210 (shown as rotation 211). Rotating the locking rod 210 allows the locking rod portion of the locking system 102 to engage the keeper portion of the locking system 102, which couples the first radial door 104 and the second radial door 106 together.

In one embodiment, the locking rod handle 224 is bolted to the locking rod 210 and is configured to pivot about the bolt (shown as rotation 225) to allow the locking rod handle 224 to be positioned at various angles with respect to the locking rod 210. In other embodiments, the locking rod handle 224 is coupled or integrated with the locking rod 210 using any other suitable technique as would be appreciated by one of ordinary skill in the art. For example, the locking rod handle 224 may be welded onto the locking rod 210.

In one embodiment, the locking system 102 comprises a seal hasp 226 configured to secure the locking rod 210 when the locking rod 210 is in the locked position. For example, the seal hasps 226 may be configured to prevent the locking rod 210 from moving once the locking rod 210 is in the locked position. In other embodiments, the locking system 102 may employ any other type of mechanism to secure the locking rod handle 224.

In one embodiment, the locking rod portion of the locking system 102 is configured to not form pinch points when the second radial door 106 is in the open position. For example, the locking rod portion is configured such that a gap is formed between any hinges or hasps and an exterior surface of the railcar 100 when the second radial door 106 is in the open position.

FIG. 3 is a front view of an embodiment of a keeper portion of the locking system 102. The keeper portion comprises a first keeper 302 and a second keeper 308 disposed proximate to an edge 109 of the first radial door 104. The first keeper 302 and the second keeper 308 may be mounted to the first radial door 104 using any suitable technique as would be appreciated by one of ordinary skill in the art. For example, the first keeper 302 and the second keeper 308 may comprise a backing plate that allows the first keeper 302 and the second keeper 308 to be bolted to the first radial door 104.

In one embodiment, the first keeper 302 is disposed on a lower portion of the first radial door 104. For example, the first keeper 302 may be positioned near the deck 114 of the railcar 100. The second keeper 308 is disposed above the first keeper 302 on the first radial door 104. The locking system 102 may be configured with any suitable spacing between the first keeper 302 and the second keeper 308 in the vertical direction along the first radial door 104. For example, the first keeper 302 and the second keeper 308 may be one foot apart, two feet apart, three feet apart, etc. In one embodiment, the second keeper 308 is proximate to a center portion of the first radial door 104. For example, the second keeper 308 may be positioned near the middle of the first radial door 104. In another embodiment, the second keeper 308 is proximate to the roof 110 of the railcar 100. In other embodiments, the second keeper 308 may be in any other suitable position on the first radial door 104.

The first keeper 302 comprises a first lobe 304 and a second lobe 306. In one embodiment, the first lobe 304 is larger than the second lobe 306 and is spherical in shape. The first lobe 304 is configured such that a first hook portion (e.g. hook portion 214) of the locking rod 210 cam (e.g. cam 212) engages the first keeper 302 by hooking underneath the first lobe 304. The second lobe 306 is configured such that a second hook portion (e.g. hook portion 216) of the locking rod 210 cam (e.g. cam 212) engages the first keeper 302 by hooking over and/or around the second lobe 306. The second lobe 306 may be configured to limit the rotation of the locking rod 210 cam once the locking rod 210 is engaged with the first keeper 302. Similarly, the second keeper 308 comprises a third lobe 310 and a fourth lobe 306. The third lobe 310 is configured similar to the first lobe 304 and the fourth lobe 312 is configured similar to the second lobe 306.

In other embodiments, the keeper portion of the locking system 102 may comprise any other suitable number of keepers. For example, the keeper portion may comprise one keeper, two keepers, three keepers, and so on.

In one embodiment, the keeper portion of the locking system 102 is configured to not form pinch points when the first radial door 104 is in the open position. For example, the keeper portion is configured such that a gap is formed between any keepers and an exterior surface of the railcar 100 when the first radial door 104 is in the open position.

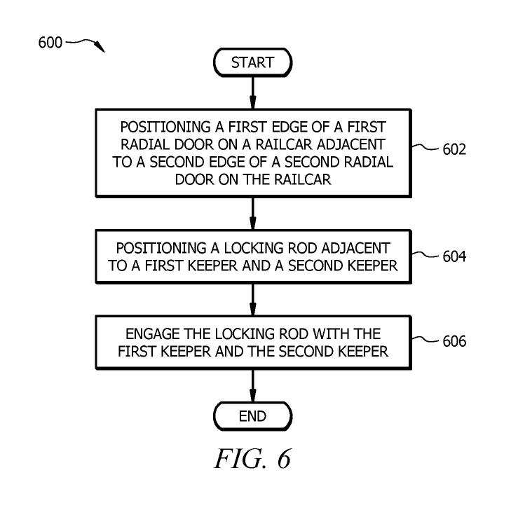

FIG. 4 is a top view of an embodiment of the locking system 102 in an unlocked position. When the locking system 102 is in the unlocked position, the first radial door 104 and the second radial door 106 are not coupled together and are able to operate independently. To transition the locking system 102 from the unlocked position to a locked position (shown in FIG. 5), an operator positions the cams (e.g. cams 212 and 218) of the locking rod 210 adjacent to corresponding keepers (e.g. keepers 302 and 308) and rotates the locking rod 210 to engage the cams with the keepers. An example of transitioning the locking system 102 from the unlocked position to the locked position is described in FIG. 6.

In one embodiment, the locking system 102 may use one or more shims 402 under the mounting plate of the keepers and/or the hinges. The shims 402 can be used to compensate for uneven or warped doors to allow for a tighter connection when the locking system 102 is in the locked position.

FIG. 5 is a top view of an embodiment of the locking system 102 in a locked position. When the locking system 102 is in the locked position, the first radial door 104 and the second radial door 106 are coupled together and are no longer able to operate independently. In other words, the first radial door 104 and the second radial door 106 cannot slide or be opened when the locking system 102 is in the locked position. When the locking system 102 is in the locked position, the locking system 102 substantially prevents the first radial door 104 and the second radial 106 from being able to be pried apart or open by a malicious person. To transition the locking system 102 from the locked position to the unlocked position (shown in FIG. 4), an operator rotates the locking rod 210 to disengage the cams (e.g. cams 212 and 218) of the locking rod 210 from corresponding keepers (e.g. keepers 302 and 308) and moves the locking rod 210 away from the keepers.

FIG. 6 is a flowchart of an embodiment of a railcar locking method 600 using the locking system 102. In one embodiment, an operator may employ method 600 to secure radial end doors of a railcar 100. For example, once the railcar 100 has been loaded, an operator may employ method 600 to secure the first radial door 104 with the second radial door 106 to prevent theft and illegal ridership.

At step 602, an operator positions the first edge 109 of the first radial door 104 adjacent to the second edge 111 of the second radial door 106. For example, the operator slides the first radial door 104 and the second radial door 106 together such that the first edge 109 of the first radial door 104 is adjacent to the second edge 111 of the second radial door 106.

At step 604, the operator positions the locking rod 210 of the locking system 102 adjacent to the first keeper 302 and the second keeper 308. As an example, the first radial door 104 comprises the keeper portion of the locking system 102 (shown in FIG. 3) and the second radial door 106 comprises the locking rod portion of the locking system 102 (shown in FIG. 2). The operator rotates the locking rod 210 about the hinges (e.g. hinges 202 and 206) to position the locking rod 210 adjacent to the keepers (e.g. keepers 302 and 308).

At step 606, the operator engages the locking rod 210 with the first keeper 302 and the second keeper 308 to transition the locking system 102 into the locked position. The operator rotates the locking rod 210 using the locking rod handle 224 to engage the cams of the locking rod 210 with the keepers, which transitions the locking rod system 102 from the unlocked position to the locked position. As the operator rotates the locking rod 210, the cams hook on to the keepers which causes the first radial door 104 and the second radial door 106 to at least partially align with each other. For example, the first hook portion of the cams may hook on to and pull on the lobe portions of the keepers to align the first radial door 104 and the second radial door 106 as the locking system 102 transitions to the locked position. The first radial door 104 and the second radial door 106 are secured together when the locking rod 210 is engaged with the keepers and the locking system 102 is in the locked position.

In one embodiment, the operator may secure the locking rod handle 224 once the locking system 102 is in the locked position. For example, the operator may use the seal hasp 226 to prevent the locking rod handle 224 from moving once the locking system 102 is in the locked position. The operator may use any suitable kind of tie or lock in conjunction with the seal hasp 226 as would be appreciated by one of ordinary skill in the art.

In one embodiment, the operator may secure at least one of the first radial door 104 and the second radial door 106 to the railcar 100 when the locking system 102 is in the locked position. For example, the operator may employ one or more locking mechanisms (e.g. locking mechanisms 108 and 112) to secure the first radial door 104 to the roof 110 and/or the deck 114 of the railcar 100. Securing one or both of the radial doors provides additional security to the railcar 100 by making the radial doors harder to pry open.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. §112(f) as it exists on the date of filing hereof unless the words “means for” or “step for” are explicitly used in the particular claim.

1. A railcar locking system comprising:
a railcar;
a first radial door comprising:
a first keeper disposed on a lower portion of the first radial door, wherein the first keeper comprises a first lobe; and
a second keeper disposed above the first keeper on the first radial door, wherein the second keeper comprises a second lobe; and
a second radial door comprising:
a first hinge disposed on a lower portion of the second radial door, wherein the first hinge comprises a first mounting bracket;
a second hinge disposed above the first hinge on the second radial door, wherein the second hinge comprises a second mounting bracket;
a locking rod comprising:
a first cam disposed at a first end of the locking rod, wherein the first cam is configured to engage with the first lobe of the first keeper when the locking rod is in a locked position;
a second cam disposed at a second end of the locking rod, wherein the second cam is configured to engage with the second lobe of the second keeper when the locking rod is in the locked position;
wherein the locking rod is configured to rotate within the first mounting bracket and the second mounting bracket;
a locking rod handle coupled to the locking rod, wherein rotating the locking rod handle about the locking rod rotates the first cam and the second cam about the locking rod;
wherein:
the locking rod is configured to at least partially align the first radial door and the second radial door when the locking rod is in the locked position; and
the first radial door is secured to the second radial door when the locking rod is in the locked position.

2. The system of claim 1, wherein the second radial door comprises a seal hasp configured to secure the locking rod handle when the locking rod is in the locked position.

3. The system of claim 1, wherein:
the first hinge comprises a first hinge gag configured to restrict the rotation of the first hinge; and
the second hinge comprises a second hinge gag configured to restrict the rotation of the second hinge.

4. The system of claim 1, wherein:
the first keeper comprise a third lobe;
the first cam is configured to engage the third lobe when the locking rod is in the locked position;
the second keeper comprises a fourth lobe; and
the second cam is configured to engage the fourth lobe when the locking rod is in the locked position.

5. The system of claim 1, wherein the first radial door comprises:
a first locking mechanism configured to secure the first radial door to a roof of the railcar; and
a second locking mechanism configured to secure the first radial door to a deck of the railcar.

6. The system of claim 1, wherein the second keeper is proximate to a roof of the railcar.

7. The system of claim 1, wherein the second keeper is proximate to a center portion of the first radial door.

8. A railcar locking method comprising:
positioning a first edge of a first radial door on a railcar adjacent to a second edge of a second radial door on the railcar, wherein:
the first radial door comprises:
a first keeper comprising a first lobe; and
a second keeper comprising a second lobe;
the second radial door comprises:
one or more hinges;
a locking rod coupled to the one or more hinges;
a first cam disposed at a first end of the locking rod; and
a second cam disposed at a second end of the locking rod;
rotating the locking rod about the one or more hinges to position the locking rod adjacent to the first keeper and the second keeper, wherein the first cam is adjacent to the first keeper and the second cam is adjacent to the second keeper when the locking rod is adjacent to the first keeper and the second keeper; and
rotating the locking rod to engage the locking rod with the first keeper and the second keeper, wherein:
the first cam is engaged with the first lobe and the second cam is engaged with the second lobe when the locking rod is engaged with the first keeper and the second keeper;
engaging the locking rod with the first keeper and the second keeper at least partially align the first radial door and the second radial door; and
the first radial door is secured to the second radial door when the locking rod is engaged with the first keeper and the second keeper.

9. The method of claim 8, further comprising securing a locking rod handle operably coupled to the locking rod.

10. The method of claim 8, wherein the first cam is engaged with a third lobe and the second cam is engaged with a fourth lobe when the locking rod is engaged with the first keeper and the second keeper.

11. The method of claim 8, further comprising securing at least one of the first radial door and the second radial door to a roof of the railcar using a locking mechanism.

12. The method of claim 8, further comprising securing at least one of the first radial door and the second radial door to a deck of the railcar using a locking mechanism.

13. The method of claim 8, further comprising:
securing at least one of the first radial door and the second radial door to a roof of the railcar using a first locking mechanism; and
securing at least one of the first radial door and the second radial door to a deck of the railcar using a second locking mechanism.

14. An apparatus comprising:
a first keeper configured to be disposed on a first door, wherein the first keeper comprises a first lobe; and
a second keeper configured to be disposed above the first keeper on the first door, wherein the second keeper comprises a second lobe; and
a first hinge configured to be disposed on a second door, wherein the first hinge comprises a first mounting bracket;
a second hinge configured to be disposed above the first hinge on the second door, wherein the second hinge comprises a second mounting bracket;
a locking rod comprising:
a first cam disposed at a first end of the locking rod, wherein the first cam is configured to engage with the first lobe of the first keeper when the locking rod is in a locked position;
a second cam disposed at a second end of the locking rod, wherein the second cam is configured to engage with the second lobe of the second keeper when the locking rod is in the locked position;
wherein the locking rod is configured to rotate within the first mounting bracket and the second mounting bracket;
a locking rod handle coupled to the locking rod, wherein rotating the locking rod handle about the locking rod rotates the first cam and the second cam about the locking rod;
wherein:
the locking rod is configured to at least partially align the first door and the second door when the locking rod is in the locked position; and
the first door is secured to the second door when the locking rod is in the locked position.

15. The apparatus of claim 14, further comprising a seal hasp configured to secure the locking rod handle when the locking rod is in the locked position.

16. The apparatus of claim 14, wherein:
the first hinge comprises a first hinge gag configured to restrict the rotation of the first hinge; and
the second hinge comprises a second hinge gag configured to restrict the rotation of the second hinge.

17. The apparatus of claim 14, wherein:
the first keeper comprise a third lobe;
the first cam is configured to engage the third lobe when the locking rod is in the locked position;
the second keeper comprises a fourth lobe; and
the second cam is configured to engage the fourth lobe when the locking rod is in the locked position.

18. The apparatus of claim 14, further comprising:
a first locking mechanism configured to secure the first door to a roof of a railcar; and
a second locking mechanism configured to secure the first door to a deck of the railcar.

19. The apparatus of claim 14, wherein the second keeper is proximate to a roof of a railcar.

20. The apparatus of claim 14, wherein the second keeper is proximate to a center portion of the first door.
